(19) United States
(12) Patent Application Publication
(10) Pub. No.: US 2016/0377810 A1
(43) Pub. Date: Dec. 29, 2016

(54) OPTICAL FIBER CLEANER AND METHOD FOR CLEANING OPTICAL FIBER

(71) Applicant: TYCO ELECTRONICS (SHANGHAI) CO. LTD, Shanghai (CN)

(72) Inventors: Hang LEE, Shanghai (CN); Zongshen LENG, Shanghai (CN); Hulfeng ZHAO, Shanghai (CN); Yongjun YUAN, Shanghai (CN); Chuanwu CHEN, Shanghai (CN); Erning XU, Shanghai (CN); Tianshuai LI, Shanghai (CN)

(21) Appl. No.: 15/039,977

(22) PCT Filed: Nov. 11, 2014
(86) PCT No.: PCT/IB2014/065955

§ 371 Date: May 27, 2016

(30) Foreign Application Priority Data
Nov. 28, 2013 (CN) 2013106252904

(51) Int. Cl. G02B 6/25; B08B 3/14

(52) U.S. Cl. CPC G02B 6/25; B08B 3/14

(57) ABSTRACT

Disclosed is an optical fiber cleaner. The optical fiber cleaner comprises an optical fiber cleaning space section (S) which has a central axis extending in a first direction, one end wall of the optical fiber cleaning space section in the first direction being provided with an optical fiber inserting hole (12) into which an optical fiber to be cleaned is inserted, and an optical cleaning space of the optical fiber cleaning space section being defined by a receiving wall (13) surrounding the optical fiber cleaning space; a cleaning agent introducing passage (20) adapted to eject a cleaning agent into the optical fiber cleaning space to clean the optical fiber inserted into the optical fiber cleaning space; and a cleaning agent collecting passage (30) provided at a lower part of the optical fiber cleaning space for discharging the cleaning agent out of the optical fiber cleaning space.

### CROSS-REFERENCE TO RELATED APPLICATION

This application claims the benefit of Chinese Patent Application No. CN201310625290.4 filed on Nov. 28, 2013 in the State Intellectual Property Office of China, the whole disclosure of which is incorporated herein by reference.

### BACKGROUND OF THE INVENTION

Field of the Invention

Embodiments of the present invention generally relate to field of automatic production of optical fibers, and more particularly to an optical fiber cleaner and a method for cleaning an optical fiber.

Description of the Related Art

Before splicing, existing optical fiber whose coating has been peeled off is usually required to be cleaned with alcohol in order to improve splicing quality and alleviate problems caused by the remained impurities of the coating, such as, uneven cutting end surface, cut blurring, impurities and difficulty in alignment of optical fibers.

Conventional methods for removing the remained impurities of the coating of the optical fiber comprise manually cleaning the optical fiber by wiping the optical fiber with tissue papers dipped with alcohol or by using a conventional ultrasonic cleaner. However, the method for cleaning the optical fiber by wiping the optical fiber with tissue papers dipped with alcohol is inefficient and requires an operator to be highly careful, otherwise, the optical fiber may be damaged, for example, be broken. Further, the method may cause the operator to be tired due to high concentration, especially for a long working time. In addition, a huge waste will be occurred due to absorption of the tissue papers to the alcohol and volatilization of the alcohol. Further, although the ultrasonic cleaner can automatically perform a cleaning operation, the cost thereof is high, and the size thereof can not be reduced due to a limitation of a vibrator, which may limit application of the ultrasonic cleaner due to the larger size thereof on automatic production lines.

### SUMMARY OF THE INVENTION

The present invention has been made to overcome or alleviate at least one aspect of the above mentioned disadvantages.

According to an aspect of the present invention, there is provided an optical fiber cleaner comprising: an optical fiber cleaning space section which has a central axis extending in a first direction, one end wall of the optical fiber cleaning space section in the first direction being provided with an optical fiber inserting hole into which an optical fiber to be cleaned is inserted, and an optical cleaning space of the optical fiber cleaning space section being defined by a receiving wall surrounding the optical fiber cleaning space; a cleaning agent introducing passage adapted to eject a cleaning agent into the optical fiber cleaning space to clean the optical fiber inserted into the optical fiber cleaning space; and a cleaning agent collecting passage provided at a lower part of the optical fiber cleaning space for discharging the cleaning agent out of the optical fiber cleaning space.

In an exemplary embodiment according to the present invention, the optical fiber inserting hole is disposed at intersection of the one end wall with the central axis, and the cleaning agent introducing passage comprises at least one set of cleaning agent ejecting holes arranged to be offset from an opening of the cleaning agent collecting passage, each set of cleaning agent ejecting holes being arranged equidistantly in a whole circumferential direction about the central axis to eject the cleaning agent towards the central axis in a radial direction.

In an alternative embodiment according to the present invention, the cleaning agent introducing passage comprises a plurality of cleaning agent introducing channels extending parallel to the central axis and arranged equidistantly in the whole circumferential direction about the central axis, the cleaning agent collecting passage is disposed to extend through the receiving wall, and the cleaning agent ejecting holes are communicated with the respective cleaning agent introducing channels, each of the cleaning agent introducing channels is communicated with the plurality of cleaning agent ejecting holes, and the diameter of each of the cleaning agent ejecting holes is smaller than that of the cleaning agent introducing channels. In a further alternative embodiment of the present invention, each of the cleaning agent ejecting holes extends through the receiving wall in the radial direction and the cleaning agent introducing channels are located within the receiving wall, and openings of the cleaning agent ejecting holes outside of the receiving wall in the radial direction are closed. In a still further alternative embodiment of the present invention, the optical fiber cleaner further comprises an enclosing wall located outside of the receiving wall, the enclosing wall being disposed around the receiving wall to close the openings of the cleaning agent ejecting holes outside of the receiving wall in the radial direction, and the cleaning agent collecting passage is disposed to extend through the enclosing wall.

In an alternative embodiment according to the present invention, the at least one set of cleaning agent ejecting holes is disposed close to the one end wall provided with the optical fiber inserting hole.

In an alternative embodiment according to the present invention, the at least one set of cleaning agent ejecting holes comprises a plurality of sets of cleaning agent ejecting holes, the plurality of sets being arranged to be spaced apart from each other along the central axis.

In an alternative embodiment according to the present invention, the optical fiber inserting hole is disposed at intersection of the one end wall with the central axis, and the cleaning agent introducing passage comprises a plurality of cleaning agent ejecting slits arranged equidistantly in a whole circumferential direction about the central axis. In a further alternative embodiment of the present invention, the cleaning agent introducing passage comprises a plurality of cleaning agent introducing channels extending parallel to the central axis and arranged equidistantly in the whole circumferential direction about the central axis, the cleaning agent collecting passage is disposed to extend through the receiving wall, and the cleaning agent ejecting slits are communicated with the respective cleaning agent introducing channels, and the width of each cleaning agent ejecting slit is smaller than that of the cleaning agent introducing channels. Further, each of the cleaning agent ejecting slits extends through the receiving wall in the radial direction and the cleaning agent introducing channels are located within the receiving wall, and openings of the cleaning agent ejecting slits outside of the receiving wall in the radial direction are closed. Still further, the optical fiber cleaner further comprises an enclosing wall located outside of the receiving wall, the enclosing wall being disposed around the receiving wall to close the openings of the cleaning agent ejecting holes outside of the receiving wall in the radial direction, and the cleaning agent collecting passage is disposed to extend through the enclosing wall.

In an alternative embodiment according to the present invention, the receiving wall comprises an inner cylinder and an outer cylinder nested with each other, and the optical fiber cleaning space is provided at a center of the inner cylinder.

In an alternative embodiment according to the present invention, the optical fiber cleaner further comprises a cleaning agent chamber into which the optical fiber cleaning space section is disposed, the cleaning agent chamber having side walls and a cover plate, wherein the other end wall of the optical fiber cleaning space section opposite to the one end wall is fixed to one of the side walls of the cleaning agent chamber, and one side wall of the cleaning agent chamber opposite to the one end wall is provided with a side wall hole for inserting the optical fiber, the side wall hole being opposed to the optical fiber inserting hole so as to allow the optical fiber to be inserted into the optical fiber inserting hole through the side wall hole, and the cleaning agent from the cleaning agent collecting passage flows into the cleaning agent chamber.

In a still further alternative embodiment of the present invention, the optical fiber cleaner further comprises a vacuum generator comprising a compressed gas tube 61 and a cleaning agent sucking tube, one end of the cleaning sucking tube being located below a liquid level of the cleaning agent within the cleaning agent chamber and the other end thereof being communicated to the compressed gas tube, wherein the cleaning agent is sucked by compressed gas at a communicating portion of the cleaning agent sucking tube with the compressed gas tube, the sucked cleaning agent is introduced into the cleaning agent introducing passage along with the compressed gas, and the cleaning agent chamber is provided with a gas outlet for allowing the gas to flow out of the cleaning agent chamber.

Alternatively, the side wall hole forms the gas outlet.

Alternatively, a attracting and closing magnetic device is disposed inside of the cover plate and on a top of the side walls of the cleaning agent chamber.

Alternatively, the other end wall is provided with a plurality of threaded holes, and a plurality of screws or bolts are adapted to pass through the side wall for fixing the optical fiber cleaning space section, and to be screwed into the corresponding threaded holes.

Alternatively, a pressure of the compressed gas is in a range of 0.4 to 0.6 Mpa.

Alternatively, the cleaning agent chamber is further provided with a liquid level sensor to sense a liquid level of the cleaning agent in the cleaning agent chamber.

According to another aspect of the present invention, there is provided a method for cleaning an optical fiber comprising: inserting the optical fiber into a cleaning space, the optical fiber being arranged to parallel to a central axis of the cleaning space; and radially ejecting a cleaning agent towards the optical fiber from a plurality of ejecting positions arranged equidistantly in a whole circumferential direction about the central axis.

Alternatively, the step of ejecting comprises sucking the cleaning agent through a compressed gas and introducing the compressed gas and the cleaning agent to the plurality of ejecting positions.

Alternatively, the method further comprises collecting the cleaning agent, which has cleaned the optical fiber, to a position at which the compressed gas is sucked.

### BRIEF DESCRIPTION OF THE DRAWINGS

The above and other features of the present invention will become more apparent by describing in detail exemplary embodiments thereof with reference to the accompanying drawings, in which:

FIG. 1 is an illustrative end view of an optical fiber cleaner according to an exemplary embodiment of the present invention;

FIG. 2 is an illustrative structural view of an optical fiber cleaner according to an exemplary embodiment of the present invention, showing a partial section of the optical fiber cleaner; and

FIG. 3 is an illustrative structural view of an optical fiber cleaner according to an exemplary embodiment of the present invention, showing a cleaning agent chamber and a vacuum generator of the optical fiber cleaner.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

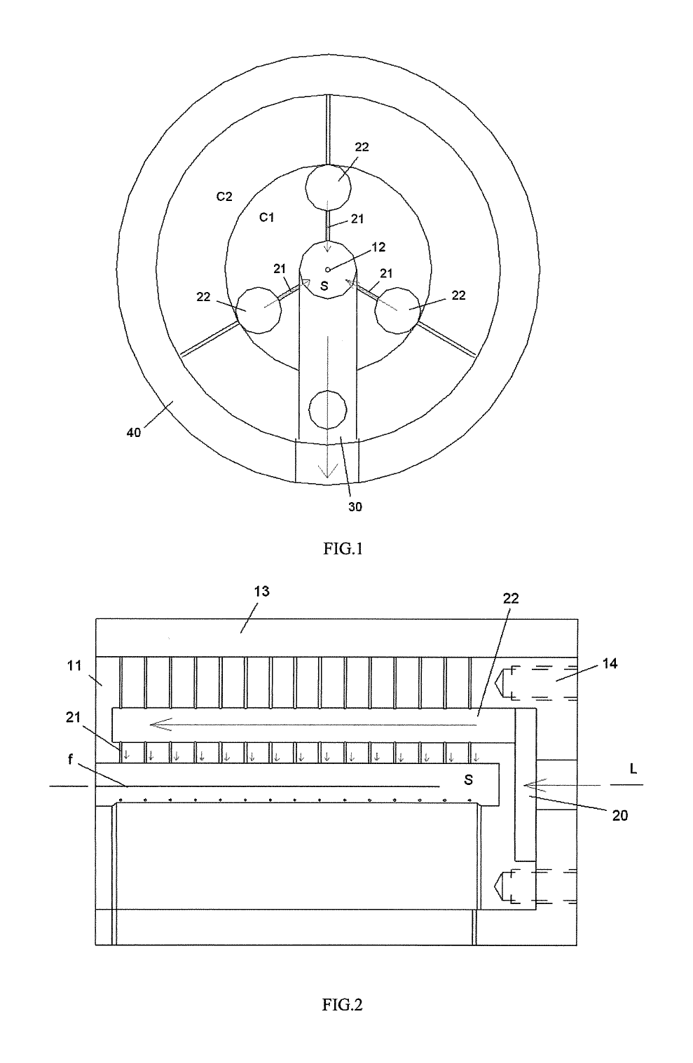

Referring to FIGS. 1 to 2, the present invention provides an optical fiber cleaner comprising:

an optical fiber cleaning space section which has a central axis L extending in a first direction, one end wall 11 of the optical fiber cleaning space section in the first direction being provided with an optical fiber inserting hole 12 into which an optical fiber f to be cleaned is inserted, and an optical cleaning space S of the optical fiber cleaning space section being defined by a receiving wall 13 surrounding the optical fiber cleaning space S;

a cleaning agent introducing passage 20 adapted to eject a cleaning agent into the optical fiber cleaning space S to clean the optical fiber f inserted into the optical fiber cleaning space; and

a cleaning agent collecting passage 30 provided at a lower part of the optical fiber cleaning space S for discharging the cleaning agent out of the optical fiber cleaning space.

The cleaning agent described herein may comprise alcohol or any other liquid for cleaning the optical fiber.

With the structure described above, since the optical fiber is directly inserted into the optical fiber cleaning space to be cleaned by the cleaning agent, it is possible to avoid manually cleaning the optical fiber by wiping the optical fiber with tissue papers dipped with alcohol in the prior art and thus avoid accidental damage (for example, breaking) to the optical fiber.

In an exemplary embodiment according to the present invention, the optical fiber inserting hole 12 is disposed at intersection of the one end wall 11 with the central axis L. The cleaning agent introducing passage 20 comprises at least one set of cleaning agent ejecting holes 21 arranged to be offset from an opening of the cleaning agent collecting passage, each set of cleaning agent ejecting holes being arranged equidistantly in a whole circumferential direction about the central axis to eject the cleaning agent towards the central axis L in a radial direction. When the optical fiber is arranged to be substantially coincided with the central axis L and each set of cleaning agent ejecting holes are arranged equidistantly in the whole circumferential direction about the central axis, an impact of the cleaning agent on the optical fiber and thus bend of the optical fiber during the cleaning can be avoided or reduced. In addition, since each set of cleaning agent ejecting holes are arranged equidistantly in the whole circumferential direction about the central axis, it is possible to ensure that a circumferential surface of the optical fiber are substantially cleaned.

In FIG. 1, each set of cleaning agent ejecting holes are arranged equidistantly at 120 degree in the whole circumferential direction about the central axis. However, each set of cleaning agent ejecting holes may be arranged equidistantly at other intervals such as 180 degree, 90 degree and the like.

The at least one set of cleaning agent ejecting holes 21 may be disposed close to the one end wall provided with the optical fiber inserting hole. In this way, when being inserted, an inserting portion of the optical fiber is cleaned upon passing through the at least one set of cleaning agent ejecting holes 21, and when being withdrawn, the inserting portion is cleaned again upon passing through the at least one set of the cleaning agent ejecting holes 21. Therefore, several cleaning operations may be performed on the optical fiber by moving the optical fiber back and forth.

In an exemplary embodiment according to the present invention, the at least one set of cleaning agent ejecting holes 21 may comprise a plurality of sets of cleaning agent ejecting holes, the plurality of sets being arranged to be spaced apart from each other along the central axis as shown in FIG. 2. In this way, after the optical fibers are inserted into the optical fiber cleaning space S, the inserting portions are cleaned synchronously.

As shown in FIG. 2, the cleaning agent ejecting holes may be a plurality of cleaning agent ejecting holes 21 spaced apart from each other along the central axis. Particularly, the cleaning agent introducing passage 20 comprises a plurality of cleaning agent introducing channels 22 extending parallel to the central axis and arranged equidistantly in the whole circumferential direction about the central axis. The cleaning agent collecting passage 30 is disposed to extend through the receiving wall. The cleaning agent ejecting holes 21 are communicated with the respective cleaning agent introducing channels 22, and each of the cleaning agent introducing channels is communicated with the plurality of cleaning agent ejecting holes 21. The diameter of each cleaning agent ejecting hole is smaller than that of the cleaning agent introducing channels.

For facilitate machining, each of the cleaning agent ejecting holes 21 extends through the receiving wall 13 in the radial direction and the cleaning agent introducing channels 22 are located within the receiving wall 13. Openings of the cleaning agent ejecting holes 21 outside of the receiving wall in the radial direction are closed. A silica gel may be used to close the openings.

FIG. 1 shows an exemplary example of closing the openings. Particularly, the optical fiber cleaner further comprises an enclosing wall 40 located outside of the receiving wall, the enclosing wall being disposed around the receiving wall to close the openings of the cleaning agent ejecting holes 21 outside of the receiving wall in the radial direction. The cleaning agent collecting passage 30 is disposed to extend through the enclosing wall 40.

The receiving wall may be divided into several separate sections which may be assembled together. The cleaning agent ejecting hole may be formed between the adjacent separate sections. The separate sections may be bonded by an adhesive or by the enclosing wall 40 shown in FIG. 1.

As illustrated in FIG. 1, the receiving wall comprises an inner cylinder C1 and an outer cylinder C2 nested with each other. The optical fiber cleaning space S is provided at a center of the inner cylinder C1. The outer cylinder C2 functions to resist flow and limit pressure.

In the embodiment described above, the cleaning agent is ejected through the cleaning agent ejecting hole. However, the cleaning agent may be ejected through slits. Particularly, similar to FIG. 1, the optical fiber inserting hole 12 is disposed at intersection of the one end wall 11 and the central axis L. The cleaning agent introducing passage 20 comprises a plurality of cleaning agent ejecting slits arranged parallel to the central axis (corresponding to the cleaning agent ejecting holes 21 as shown in FIG. 1, i.e., the cleaning agent ejecting slits are illustrated in a same way to the cleaning agent ejecting holes in an end view). The cleaning agent ejecting slits are arranged equidistantly in a whole circumferential direction about the central axis. More particularly, the cleaning agent introducing passage comprises a plurality of cleaning agent introducing channels 22 extending parallel to the central axis and arranged equidistantly in the whole circumferential direction about the central axis. The cleaning agent collecting passage 30 is provided to extend through the receiving wall. The cleaning agent ejecting slits are communicated with the respective cleaning agent introducing channels 22. The width of each of the cleaning agent ejecting slits is smaller than the diameter of the cleaning agent introducing channels. Similarly, each of the cleaning agent ejecting slits extends through the receiving wall in the radial direction and the cleaning agent introducing channels are located within the receiving wall. Openings of the cleaning agent ejecting slits outside of the receiving wall in the radial direction are closed. The optical fiber cleaner further comprises an enclosing wall 40 located outside of the receiving wall, the enclosing wall being provided around the receiving wall to close the openings of the cleaning agent ejecting slits outside of the receiving wall in the radial direction. The cleaning agent collecting passage is provided to extend through the enclosing wall.

As appreciated by those skilled in the art, in the present invention, the cleaning agent introduced into the cleaning agent introducing passage enters the optical fiber cleaning space only through the cleaning agent ejecting holes or slits.

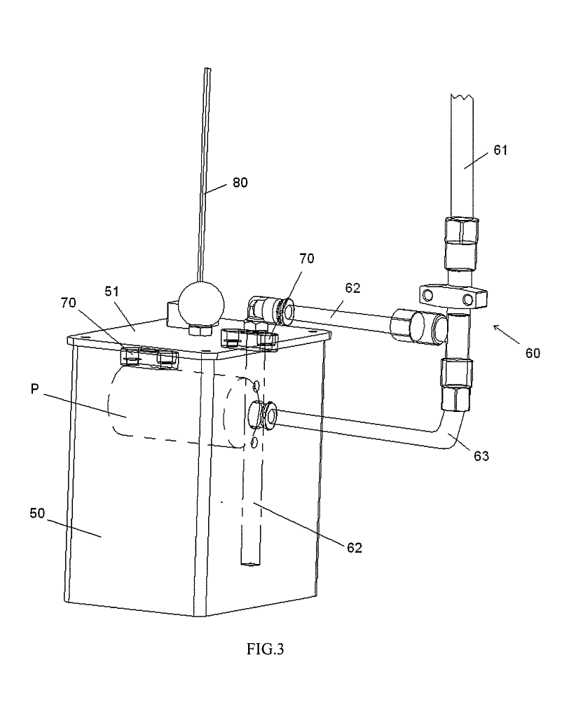

An optical fiber cleaner according to an exemplary embodiment of the present invention will be described below with reference to FIG. 3.

As shown in FIG. 3, the optical fiber cleaner as described above further comprises a cleaning agent chamber 50 into which the optical fiber cleaning space section P is disposed, the cleaning agent chamber having side walls and a cover plate 51. The other end wall (the right end wall in FIG. 3) of the optical fiber cleaning space section opposite to the one end wall (the left end wall in FIG. 3) is fixed to one of the side walls of the cleaning agent chamber, and one side wall of the cleaning agent chamber opposite to the one end wall is provided with a side wall hole for inserting the optical fiber (not shown), the side wall hole being opposed to the optical fiber inserting hole so as to allow the optical fiber to be inserted into the optical fiber inserting hole through the side wall hole. The cleaning agent from the cleaning agent collecting passage flows into the cleaning agent chamber.

Furthermore, the optical fiber cleaner may further comprise a vacuum generator 60 including a compressed gas tube 61 and a cleaning agent sucking tube 62. As shown in FIG. 3, one end of the cleaning sucking tube 62 is located below a liquid level of the cleaning agent within the cleaning agent chamber, and the other end is communicated to the compressed gas tube 61. The cleaning agent is sucked by compressed gas at a communicating portion of the cleaning agent sucking tube 62 with the compressed gas tube 61, and the sucked cleaning agent is introduced into the cleaning agent introducing passage along with the compressed gas. The cleaning agent chamber is provided with a gas outlet for allowing the gas to flow out of the cleaning agent chamber. In an exemplary embodiment according to the present invention, the side wall hole forms the gas outlet. The gas outlet may comprise other structures such as an opening disposed on the cover plate.

In an exemplary embodiment according to the present invention, an attracting and closing magnetic device 70 is disposed inside of the cover plate and on a top of the side walls of the cleaning agent chamber. The cover plate can increase tightness of the cleaning agent chamber. In a case where the cleaning agent is a volatile liquid such as alcohol, the cover plate can be attracted by the attracting and closing magnetic device 70 with magnetism, thereby reducing the volatilization of the volatile cleaning agent from a gap between the cover plate and the top of the side walls.

As illustrated in FIG. 2, the other end wall (the right end wall in FIG. 2) is provided with a plurality of threaded holes 14. A plurality of screws or bolts are adapted to pass through the side wall for fixing the optical fiber cleaning space section and to be screwed into the corresponding threaded holes to fix the optical fiber cleaning space section within the cleaning agent chamber. The end wall 11 of the optical fiber cleaning space section may also be provided with threaded holes for fixing the end wall to the side wall of the cleaning agent chamber.

In an exemplary embodiment of the present invention, a pressure of the compressed gas is in a range of 0.4 to 0.6 Mpa, preferably 0.5 Mpa. The compressed gas may be provided by a conventional air compressor. In an exemplary embodiment according to the present invention, the compressed gas may comprise other gases such as nitrogen. The gas flowing out of the cleaning agent chamber may also be recovered and recycled.

In an exemplary embodiment according to the present invention, as shown in FIG. 1, the diameter of the cleaning agent introducing channel 22 is 6 mm for example, and the diameter of the cleaning agent ejecting hole is 0.8 to lmm for example.

The cleaning agent chamber is further provided with a liquid level sensor 80 to sense the liquid level of the cleaning agent in the cleaning agent chamber.

An operating process of the optical fiber cleaner as described above will be described below.

Firstly, inserting an optical fiber into an optical fiber hole, i.e., inserting a bare optical fiber without coatings from a side wall of an alcohol tank (corresponding to the cleaning agent chamber) into a cleaning tank (corresponding to the optical fiber cleaning space S) through the optical fiber inserting hole 12.

Secondly, supplying compressed gas to the compressed gas tube 61 by using the vacuum generator to cause alcohol to be sucked into the cleaning agent sucking tube 62 and then eject the alcohol from a mixing tube 63. The alcohol ejected from the mixing tube 63 enters the cleaning agent introducing channels 22 respectively and then enters the cleaning agent ejecting holes 21. As shown in FIG. 1, with a pressure difference, the alcohol is ejected at a high speed in three directions toward the optical fiber in the optical fiber cleaning tank respectively from three ejecting holes arranged equidistantly to perform a cleaning operation on the bare optical fiber with impurity substance thereon. The ejected alcohol then flows to an alcohol backflow tank (corresponding to the cleaning agent collecting passage) after performing the cleaning operation, and then flows to the alcohol tank by gravity. The vacuum generator introduces the alcohol in the alcohol tank into the optical fiber cleaning space with the pressure difference of the fluid. A liquid level sensor may be provided for sensing volume of the alcohol in the alcohol tank. When the liquid level of the alcohol in the alcohol tank is lower than a predetermined liquid level, it is possible to warn an operator to fill the alcohol tank with the alcohol in time.

Therefore, the present invention further provides a method for cleaning an optical fiber comprising: inserting the optical fiber into a cleaning space, the optical fiber being arranged to parallel to a central axis of the cleaning space; and radially ejecting a cleaning agent towards the optical fiber from a plurality of ejecting positions arranged equidistantly in a whole circumferential direction about the central axis.

In an exemplary embodiment according to the present invention, the step of ejecting comprises sucking the cleaning agent through compressed gas and introducing the compressed gas and the cleaning agent to the plurality of ejecting positions.

In an exemplary embodiment according to the present invention, the above method further comprises collecting the cleaning agent, which has cleaned the optical fiber, to a position at which the compressed gas is sucked.

As shown in FIG. 3, the optical fiber cleaner of the present invention employs the vacuum generator and the whole optical fiber cleaner is designed as a closed circulating system, thereby effectively avoiding waste due to the volatilization of the volatile cleaning agent such as the alcohol. At the same time, it is possible to realize a complete cleaning of the bare optical fiber through the ejections in multiple directions. In addition, it is possible to control a size of the entire optical fiber cleaner to satisfy requirements regarding automatic production of the existing optical fiber. Further, the liquid level sensor is adopted in the optical fiber cleaner of the present invention to effectively monitor the liquid level of the cleaning agent in the cleaning agent tank so that the cleaning agent is supplied in time when the cleaning agent is insufficient.

It would be appreciated by those skilled in the art the embodiment as described and shown above are exemplary and various changes or modifications may be made thereto. Structures described in various embodiments may be combined in any forms without conflicting with each other in structure or concept of the present invention to achieve various electrical connectors to solve the technical problem of the present invention.

After describing and showing the preferable embodiments of the present invention in details, it would be appreciated by those skilled in the art that various changes or modifications may be made in these embodiments without departing from the principle and spirit of the disclosure, and the present invention is not limited to the exemplary embodiment as described and shown above.

What is claimed is:

1. An optical fiber cleaner comprising:
an optical fiber cleaning space section which has a central axis extending in a first direction, one end wall of the optical fiber cleaning space section in the first direction being provided with an optical fiber inserting hole into which an optical fiber to be cleaned is inserted, and an optical cleaning space of the optical fiber cleaning space section being defined by a receiving wall surrounding the optical fiber cleaning space;
a cleaning agent introducing passage adapted to eject a cleaning agent into the optical fiber cleaning space to clean the optical fiber inserted into the optical fiber cleaning space; and
a cleaning agent collecting passage provided at a lower part of the optical fiber cleaning space for discharging the cleaning agent out of the optical fiber cleaning space.

2. The optical fiber cleaner according to claim 1, wherein
the optical fiber inserting hole is disposed at intersection of the one end wall with the central axis;
the cleaning agent introducing passage comprises at least one set of cleaning agent ejecting holes arranged to be offset from an opening of the cleaning agent collecting passage, each set of cleaning agent ejecting holes being arranged equidistantly in a whole circumferential about the central axis to eject the cleaning agent towards the central axis in a radial direction.

3. The optical fiber cleaner according to claim 2, wherein
the cleaning agent introducing passage comprises a plurality of cleaning agent introducing channels extending parallel to the central axis and arranged equidistantly in the whole circumferential direction about the central axis;
the cleaning agent collecting passage is disposed to extend through the receiving wall; and
the cleaning agent ejecting holes are communicated with the respective cleaning agent introducing channels, each of the cleaning agent introducing channels is communicated with the plurality of cleaning agent ejecting holes, and the diameter of each of the cleaning agent ejecting holes is smaller than that of the cleaning agent introducing channels.

4. The optical fiber cleaner according to claim 3, wherein
each of the cleaning agent ejecting holes extends through the receiving wall in the radial direction and the cleaning agent introducing channels are located within the receiving wall; and
openings of the cleaning agent ejecting holes outside of the receiving wall in the radial direction are closed.

5. The optical fiber cleaner according to claim 4, wherein
the optical fiber cleaner further comprises an enclosing wall located outside of the receiving wall, the enclosing wall being disposed around the receiving wall to close the openings of the cleaning agent ejecting holes outside of the receiving wall in the radial direction; and
the cleaning agent collecting passage is disposed to extend through the enclosing wall.

6. The optical fiber cleaner according to claim 2, wherein
the at least one set of cleaning agent ejecting holes is disposed close to the one end wall provided with the optical fiber inserting hole.

7. The optical fiber cleaner according to claim 2, wherein
the at least one set of cleaning agent ejecting holes comprises a plurality of sets of cleaning agent ejecting holes, the plurality of sets being arranged to be spaced apart from each other along the central axis.

8. The optical fiber cleaner according to claim 1, wherein
the optical fiber inserting hole is disposed at intersection of the one end wall with the central axis; and
the cleaning agent introducing passage comprises a plurality of cleaning agent ejecting slits arranged equidistantly in a whole circumferential direction about the central axis.

9. The optical fiber cleaner according to claim 8, wherein
the cleaning agent introducing passage comprises a plurality of cleaning agent introducing channels extending parallel to the central axis and arranged equidistantly in the whole circumferential direction about the central axis;
the cleaning agent collecting passage is disposed to extend through the receiving wall; and
the cleaning agent ejecting slits are communicated with the respective cleaning agent introducing channels, and the width of each cleaning agent ejecting slit is smaller than the diameter of the cleaning agent introducing channels.

10. The optical fiber cleaner according to claim 9, wherein
each of the cleaning agent ejecting slits extends through the receiving wall in the radial direction and the cleaning agent introducing channels are located within the receiving wall; and
openings of the cleaning agent ejecting slits outside of the receiving wall in the radial direction are closed.

11. The optical fiber cleaner according to claim 10, wherein
the optical fiber cleaner further comprises an enclosing wall located outside of the receiving wall, the enclosing wall being disposed around the receiving wall to close the openings of the cleaning agent ejecting holes outside of the receiving wall in the radial direction; and
the cleaning agent collecting passage is disposed to extend through the enclosing wall.

12. The optical fiber cleaner according to claim 1, wherein
the receiving wall comprises an inner cylinder and an outer cylinder nested with each other; and
the optical fiber cleaning space is provided at a center of the inner cylinder.

13. The optical fiber cleaner according to claim 1, further comprising
a cleaning agent chamber into which the optical fiber cleaning space section is disposed, the cleaning agent chamber having side walls and a cover plate,
wherein the other end wall of the optical fiber cleaning space section opposite to the one end wall is fixed to one of the side walls of the cleaning agent chamber, and one side wall of the cleaning agent chamber opposite to the one end wall is provided with a side wall hole for inserting the optical fiber, the side wall hole being opposed to the optical fiber inserting hole so as to allow the optical fiber to be inserted into the optical fiber inserting hole through the side wall hole; and
wherein the cleaning agent from the cleaning agent collecting passage flows into the cleaning agent chamber.

14. The optical fiber cleaner according to claim 13, further comprising
a vacuum generator comprising a compressed gas tube and a cleaning agent sucking tube, one end of the cleaning sucking tube being located below a liquid level of the cleaning agent within the cleaning agent chamber and the other end thereof being communicated to the compressed gas tube, wherein the cleaning agent is sucked by compressed gas at a communicating portion of the cleaning agent sucking tube with the compressed gas tube, and the sucked cleaning agent is introduced into the cleaning agent introducing passage along with the compressed gas,
wherein the cleaning agent chamber is provided with a gas outlet for allowing the gas to flow out of the cleaning agent chamber.

15. The optical fiber cleaner according to claim 14, wherein
the side wall hole forms the gas outlet.

16. The optical fiber cleaner according to claim 13, wherein
a attracting and closing magnetic device is disposed inside of the cover plate and on a top of the side walls of the cleaning agent chamber.

17. The optical fiber cleaner according to claim 13, wherein
the other end wall is provided with a plurality of threaded holes; and
a plurality of screws or bolts are adapted to pass through the side wall for fixing the optical fiber cleaning space section, and to be screwed into the corresponding threaded holes.

18. The optical fiber cleaner according to claim 13, wherein
a pressure of the compressed gas is in a range of 0.4 to 0.6 Mpa.

19. The optical fiber cleaner according to claim 13, wherein
the cleaning agent chamber is further provided with a liquid level sensor to sense a liquid level of the cleaning agent in the cleaning agent chamber.

20. A method for cleaning an optical fiber, comprising
inserting the optical fiber into a cleaning space, the optical fiber being arranged to parallel to a central axis of the cleaning space; and
radially ejecting a cleaning agent towards the optical fiber from a plurality of ejecting positions arranged equidistantly in a whole circumferential direction about the central axis.

21. The method according to claim 20, wherein
the step of ejecting comprises sucking the cleaning agent through a compressed gas and introducing the compressed gas and the cleaning agent to the plurality of ejecting positions.

22. The method according to claim 21, further comprising
collecting the cleaning agent, which has cleaned the optical fiber, to a position at which the compressed gas is sucked.
